(19) United States
(12) Patent Application Publication
(10) Pub. No.: US 2007/0298921 A1
(43) Pub. Date: Dec. 27, 2007

(54) Plate-link chain and rocker member for a belt-driven conical-pulley transmission

(75) Inventors: Emmanuel Simon, Herrlisheim (FR); Martin Vornehm, Wooster, OH (US); Anton Simonov, Buhl (DE); Aurel Vietoris, Buhl (DE); Christoph Mayerhofer, Ottersweier (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/809,212

(22) Filed: May 31, 2007

Related U.S. Application Data
(60) Provisional application No. 60/810,498, filed on Jun. 2, 2006.

(51) Int. Cl. F16G 13/04

(52) U.S. Cl. 474/215

(57) ABSTRACT

A plate-link chain for a motor vehicle drive system including conical pulleys. The chain includes a number of link plates hingedly connected with each other by rocker members. The rocker members extend transversely to the longitudinal direction of the plate-link chain and are situated in openings in the link plates. The rocker members have end faces for frictional contact with conical surfaces of disks of a belt-driven conical-pulley transmission, and the rocker member end faces are configured so that contact between the rocker member end faces and the conical surfaces of the disks takes place in the upper region of the end faces, relative to the height direction of the rocker members.

### BACKGROUND OF THE INVENTION

1. Field of the Invention

The present invention relates to a plate-link chain, particularly for a belt-driven conical pulley transmission forming part of a motor vehicle drive system. The invention also relates to a rocker member for a plate-link chain, with a rolling surface for contact with an assigned rocker member of a pair of rocker members, and curved contact surfaces situated largely opposite the rolling surface, as well as end faces for frictional contact with conical pulleys of a belt-driven conical-pulley transmission. The invention also relates to a belt-driven conical-pulley transmission equipped with a chain, with an input-side and an output-side conical pulley and a plate-link chain having rocker members for transmitting torque.

2. Description of the Related Art

Plate-link chains have a large number of link plates that are pivotally connected with each other by rocker members that extend transversely to the longitudinal direction of the plate-link chain. The rocker members are positioned in openings of the link plates and include curved contact surfaces located on each of the rocker members and on the link plates, along which contact surfaces the rocker members and link plates bear against each other to transmit power. The contact surfaces are provided on the upper and lower contact surface region, considered in the rocker member height direction, between a rocker member and a link plate. Curved rolling surfaces are situated on the rocker members, along which the rocker members roll against each other to transmit power, and the rocker members have end faces for frictional contact with conical disks of a belt-driven conical-pulley transmission.

Belt-driven conical-pulley transmissions in accordance with the genre have already come to be known in several versions. Plate-link chains that run on the conical pulleys are employed, for example, as the endless means of transmitting torque between the input side and the output side conical pulleys. Plate-link chains employed for that purpose have rocker members that come into contact with the conical pulley surfaces at their respective end faces, and they thereby transmit a torque from the input side conical pulley to the output side conical pulley.

In accordance with the prevailing view, the contact between the conical pulleys and the rocker members takes place along a polygonal curve on the conical surfaces of the pulleys. Because the individual rocker members are spaced at intervals from each other, viewed in the running direction of the chain, as the plate-link chain runs around the conical pulleys, the rocker members come into contact with the conical pulleys one after another, so that as the end faces of the rocker members contact the conical pulleys an impact occurs, resulting in excitation of structure-borne noise in the conical disks.

As already mentioned above, the end faces of the rocker members serve to transfer frictional force between the input side conical pulley and the plate-link chain, and between the plate-link chain and the output side conical pulley. Since the issue is therefore transmission of force with reduced friction, in accordance with the design heretofore the rocker members were configured so that transmission of frictional force between the conical disk surfaces and the end faces of the rocker members takes place along the entire rocker member end face, and the end faces were therefore used in their entirety as the contact zone, since that was supposed to be favorable in terms of wear because of the associated distribution of the wear on the end faces.

If a plate-link chain portion enters between the pair of conical disks of a conical pulley, a bending of the plate-link chain occurs, which is caused by the chain tension, and which occurs at a place where the conical pulley begins to exert a force on the plate-link chain. In accordance with prevailing opinion, that is understood to be a polygonal course. Similarly, the entry process of the rocker members between the pairs of conical disks takes place during a very brief transition zone, during which the previously-mentioned impact occurs, in which impulse excitation of the conical pulley thus occurs during a very short time period with a hammer-blow-like entry effect, and corresponding excitation of structure-borne noise, which results in negative acoustical properties.

If a form of the plate-link chain or of the conical pulleys, and hence of the belt-driven conical-pulley transmission, is produced that reduces that hammer-blow effect, the result on the one hand is a more wear-favorable behavior of the plate-link chain and of the belt-driven conical-pulley transmission, as well as acoustically more advantageous running of the plate-link chain and hence of the belt-driven conical-pulley transmission as a whole.

Starting from that premise, an object of the present invention is to refine a plate-link chain that is known, for example from DE 199 58 073 A1, in such a way that the running behavior of the plate-link chain undergoes improvement with regard to acoustics, and the wear behavior of the rocker members is also improved.

### SUMMARY OF THE INVENTION

The present invention is based upon the recognition that the design of the contact zone between the rocker members and the conical pulleys is established by the contour pairing of the contour of the rocker member and the contour of the conical disk. In accordance with the currently known plate-link chains, the end faces of the rocker members are utilized in their entirety as a contact zone. That means, in other words, that when going through the complete range of transmission ratios of a continuously variable, belt-driven conical-pulley transmission, the end face region of the rocker members is completely traversed from the lower end face region to the upper end face region. That approach is also based upon the consideration that the wear can also be distributed over the entire end face in that way, so that a reduction in wear is achieved.

Departing from the above model, the present invention provides a plate-link chain, in particular for a motor vehicle drive system, with a large number of link plates pivotally connected with each other by rocker members. The rocker members extend transversely to the longitudinal direction of the plate-link chain and are situated in openings of the link plates. Curved contact surfaces are located on each of the rocker members and on the link plates, along which the rocker members and link plates bear against each other to transmit power. Curved rolling surfaces are situated on the rocker members, along which the rocker members roll against each other to transmit power. The rocker members have end faces for frictional contact with conical disks of a belt-driven conical-pulley transmission, the end faces being configured in such a way that contact between the rocker members and the conical disks takes place in the upper region of the end faces, considered in the rocker member height direction.

The present invention thereby provides a plate-link chain whose rocker members have end faces on which a partial region of the end face is excluded from contact with the conical disks. The invention has led to the surprising recognition that, although a partial region of the end faces of the rocker members available for power transmission is no longer utilized, nevertheless wear-favorable behavior of the plate-link chain is achieved despite the reduction in size of the available contact zone on the rocker members, and that in addition that change is acoustically advantageous.

In accordance with a refinement of the present invention, provision is made so that the contact region on the end faces extends over about 65% to about 85% of the height direction of the rocker member. A further result of that is that of the entire end face of a rocker member for power transmission, and thus for contact with the conical disk surfaces, only about 65% to about 85% is still used for power transmission, and that despite that reduction in size of the usable contact surface of the rocker members, both a more wear-favorable and a more acoustically favorable behavior of the plate-link chain results.

In accordance with a further refinement of the present invention, provision is made so that the end faces have increasing curvature from the upper to the lower region in the height direction of the rocker members. The effect of that curvature is that when traversing the end face region of the rocker members available for power transmission, the lower region in the rocker member height direction of about 15% to about 35%, which corresponds to some 15 to 35% of the total region of the end face of a rocker member, is excluded from the transmission of force and thus from contact with the conical disk surfaces.

In very general terms, the form of the end faces of the rocker members in accordance with the present invention is chosen so that the end faces have a curvature in their lower region such that during the contact of the rocker members with the conical disks, a free space, and thus a gap, remains between the end faces and the conical disks.

The result of that form in accordance with the present invention is that when rocker members enter into an intermediate space between conical disks, a tilting moment develops in the rocker members, which exerts a force on a following chain portion in the running direction, so that an entry radius of curvature of the entering portion of the chain is greater than an encircling radius of the chain relative to the conical disks.

In plate-link chains, rocker members lie opposite each other in pairs in openings of the link plates. Thus, one rocker member is firmly connected to one link plate and the opposing rocker member is firmly connected to an adjacent link plate, and a rolling process takes place between two opposing rocker members during the bending process, i.e., a transition of the link plates from an extended position to a pivoted position. If a rocker member designed in accordance with the invention now comes into contact with the conical disks during an entry process of the plate-link chain into the intermediate space between two conical disks, the result is a tilting moment acting on the following link plate in the running direction—i.e., for example in the case of the right rocker member of a pair of rocker members which is entering into the intermediate space between two conical disks, onto the left-side link plate in the running direction. That tilting moment exerts on the link plate, and thus on the chain portion, a force in the radially outward direction, viewed from the central axis of the conical disks, so that the entry curvature radius of the chain portion becomes greater than the encircling radius of the chain as it passes around the conical disks, and hence the entry trajectory is smoothed and the entry impulse is lessened.

Thus, a continuous and hence gentler transition of the chain portion from straight-line running to curved running occurs, which results in a time prolongation of the transition of the chain portion from a straight strand portion to an encircling portion, and thus no longer to a digital transition, as was formerly the case. The result is that the time available for the transition is prolonged and hence the entry impulse is reduced, which is accompanied by a reduction of the hammer-blow effect described earlier, and hence also to quieter running of the plate-link chain, and thus to a reduction of the outwardly manifested noises of the belt-driven conical-pulley transmission.

The invention also provides a rocker member for a plate-link chain, with a rolling surface for contact with an assigned rocker member of a pair of rocker members, and with curved contact surfaces situated largely opposite the rolling surfaces, as well as end faces for frictional contact with conical disks of a belt-driven conical-pulley transmission. The end faces of the rocker member are configured so that contact between the rocker member and the conical disks takes place in the upper region of the end faces, considered in the height direction of the rocker member.

In order to achieve the result that contact between the rocker member end faces and the conical disks occurs on the upper region of the end faces in the height direction of the rocker member, a refinement of the invention provides that the end faces have increasing curvature from the upper to the lower region in the height direction of the rocker member, such that a contact region on a particular end face involves about 65% to 85% of the end face area. Thus, of the respective total area of each end face, about 65% to about 85% of the end face area is available on the rocker members for contact with the conical disks, so that about 15% to about 35% of the end face area does not make contact with the conical disks.

The invention also provides a belt-driven conical-pulley transmission with an input side and an output side conical pulley and a plate-link chain with rocker members for torque transmission. The conical disks are configured in such a way that the contact between the rocker members and the conical disks takes place in the upper region of the end faces of the rocker members, considered in the height direction of the rocker members. For that purpose, it is possible in accordance with the invention for the conical surfaces to be of a curved design, for example, and for the curvature of the conical surfaces of the disks to increase as the radius of the conical disks increases. The result of that form is that on the contact pair conical disk surface to rocker member end face surface, for example, there is no complementary tangential angle available to ensure contact between the end face of the rocker member and the conical disk surface, so that the rocker member in turn does not come into contact with the conical disk surfaces with its lower end face region.

### BRIEF DESCRIPTION OF THE DRAWINGS

The structure, operation, and advantages of the present invention will become further apparent upon consideration of the following description, taken in conjunction with the accompanying drawings in which:

FIG. 1 shows a schematic side view of a length of a known plate-link chain in a deflection process as it passes around a conical pulley;

FIG. 2 is a view similar to FIG. 1 and shows the circumstances during the running around a conical pulley of a plate-link chain in accordance with the invention;

FIG. 3A is an end view showing the measured wear on the end faces of two rocker members of the known plate-link chain;

FIG. 3B is an end view similar to FIG. 3A, but showing the wear on two rocker members of a plate-link chain in accordance with an embodiment of the present invention;

FIG. 4A is a graph showing the frictional load during the contact of a rocker member with a conical disk at the input conical pulley and at the output conical pulley, when the contact between the rocker members and the conical disks takes place in the lower region of the end faces of the rocker member, considered in the height direction of the rocker members;

FIG. 4B is a graph similar to FIG. 4A, but showing the frictional load during the contact of a rocker member with a conical disk at the input conical pulley and at the output conical pulley, when the contact between the rocker members and the conical disks takes place in the upper region of the end faces of the rocker member, considered in the height direction of the rocker members;

FIG. 5 is a graph of the noise level of a known plate-link chain and of a plate-link chain in accordance with the present invention;

FIG. 6A is a graph of the measured tensile force pattern of a link plate in a known plate-link chain;

FIG. 6B is a graph similar to FIG. 6A, but showing the tensile force pattern of a link plate in a plate-link chain in accordance with the present invention;

FIG. 7 shows in the left half of the drawing a fragmentary cross-sectional view of a portion of a conical disk surface with a rocker member against it, and in the right half of the drawing an enlarged fragmentary cross-sectional view of the rocker member end surface; and

FIG. 8 is a view similar to FIG. 7, but showing in the right half of the drawing an enlarged fragmentary cross-sectional view of a rocker member end surface in accordance with the invention.

### DESCRIPTION OF THE PREFERRED EMBODIMENTS

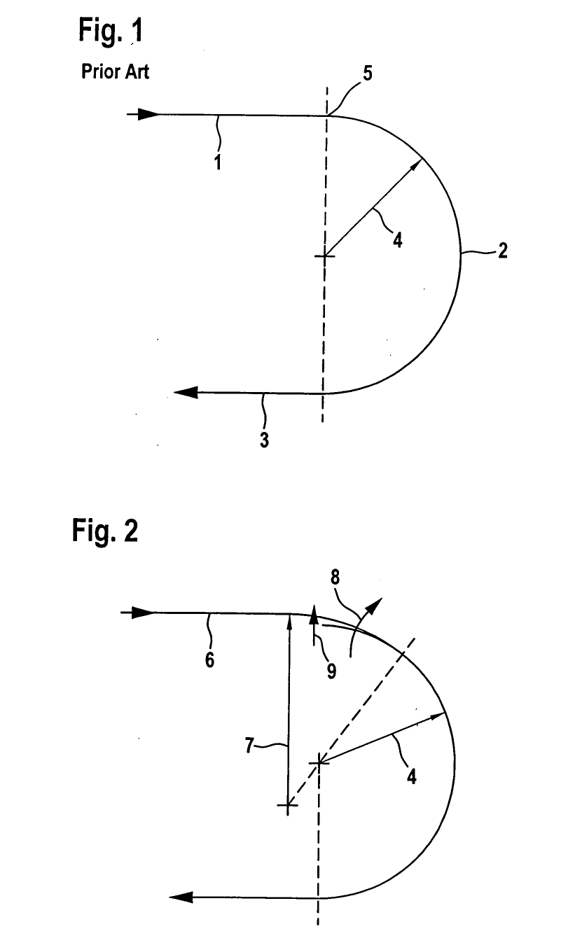

FIG. 1 shows the form assumed by a portion of a known plate-link chain in the extended zone 1, before a deflection in curved zone 2 as it passes around and between the conical disks of a conical pulley, and then again an extended zone 3 after emerging from the conical pulley. Before a chain portion reaches the space between the conical disks of a conical pulley, it has a straight, extended form in extended zone 1. During its contact with the conical pulley in curved zone 2 it assumes a curved form that corresponds with an encircling radius 4. When the chain portion has again left the space between the conical disks of the conical pulley it again assumes a straight, extended form in extended zone 3.

In that case the transition from the extended form in extended in extended zone 1 to the curved form in curved zone 2 takes place at the transition point 5. The bending of the plate-link chain into a curved form is caused by the tension on the chain, and it begins at the location referred to as transition point 5, at which the conical disks begin to exert a force on the plate-link chain.

The transition region is understood to be temporally or spatially small or short, an incremental transition as it were from the extended form to the curved form; one can speak of running along a polygonal curve. As the rocker members of the chain portion enter the gap defined by the conical pulley an impulse occurs that produces the effect of a hammer-blow, which is described by the term “impact.” Because of the incremental transition as it were at transition point 5, the chain portion undergoes a high acceleration and thus a large application of force during a very short period of time, which results in acoustically unfavorable running behavior with high measurable noise levels.

FIG. 2 shows a section of a span of a chain portion of a plate-link chain in accordance with the present invention.

Because of the design of the plate-link chain in accordance with the invention, contact between the rocker members and the conical disks occurs at the upper regions of the end faces of the rocker members, considered in the height direction of the rocker members. As the rocker members enter into the intermediate space between two conical disks, that contact causes a tilting moment to develop in the rocker members, which exerts a force on the following chain portion in the running direction, such that the entry radius of curvature of that following chain portion as it begins to enter the space between the conical disks is greater than the encircling radius defined by the chain as it passes around the conical disks.

FIG. 2 makes that situation clear. Reference numeral 6 designates a zone or a section of chain that is associated with the following chain portion that was mentioned earlier. By shifting the contact point between the rocker members and the conical disks into the upper region of the end faces of the rocker members, a tilting moment develops in the rocker member, which acts on the trailing link plate that is in firm contact with the rocker member and results in a shifting of the chain path in a radially outward direction. Consequently, the entry trajectory of the rocker members of the trailing link plates is smoothed and the latter therefore no longer execute as it were an incremental transition from a straight or extended position to a curved position when entering the space between the conical disks. Instead, they enter into the space between the conical disks in a position that is already slightly deflected from the extended position, and they thereby already undergo a force component that corresponds to the force component on the chain portion during the curving of the chain as it passes around and between the pairs of conical disks.

Compared to the incremental transition, as it were, from the extended position to the curved position in FIG. 1, a continuous transition from the extended position to the curved position of the chain portion is caused to occur. There is a less strongly defined hammer-blow effect, the entry impulse upon the entry of the rocker members of the following chain portions into the conical pulley becomes milder, and the acoustical impact due to the entry effect likewise decreases. A belt-driven conical-pulley transmission equipped with the plate-link chain configured in accordance with the present invention produces less structure-borne noise, and therefore manifests itself more quietly to the outside. While the arrow designated by reference numeral 4 represents the encircling radius, the arrow designated by reference numeral 7 describes the entry radius of curvature of the following chain portion, which is larger than the encircling radius 4, a fact attributable to the tilting moment in the rocker members that precede the following chain portion, already described earlier, as shown in FIG. 2 by arrow 8 and the force arrow 9 pointing in the radially outward direction.

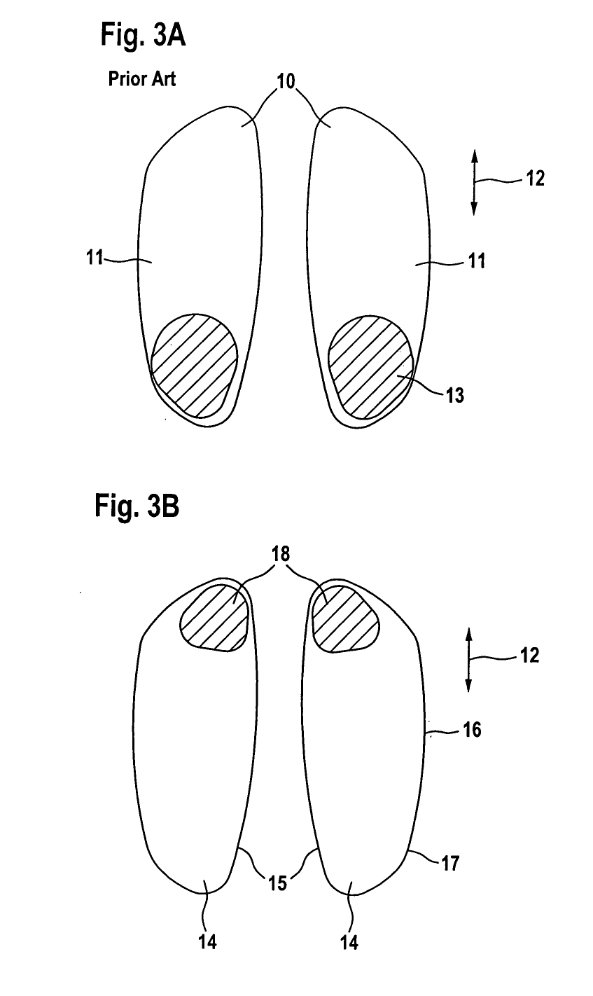

FIG. 3A shows a rocker member pair with rocker members 10 of a known plate-link chain. In those known rocker members 10, the contact point on the end faces 11 is in the lower region, considered in the height direction of the rocker members and viewed in accordance with the double headed arrow 12. The sectioned region 13 shows wear marks that represent the measured material removal after a wear test.

FIG. 3B shows rocker members 14 of a plate-link chain in accordance with the present invention. Rocker members 14 have curved rolling surfaces 15 that face each other, and outwardly-facing contact surfaces 16, 17, by which rocker members 14 bear against corresponding contact surfaces of the link plates (not shown in detail). The sectioned regions 18 in FIG. 3B show wear marks of measured material removal after a wear test that corresponds to the wear test to which the rocker members 10 of the known plate-link chain shown in FIG. 3A were subjected. As can be clearly seen, the sectioned regions 18 of the rocker members 14 in accordance with the invention are significantly smaller than the sectioned regions 13 of the known rocker members 10.

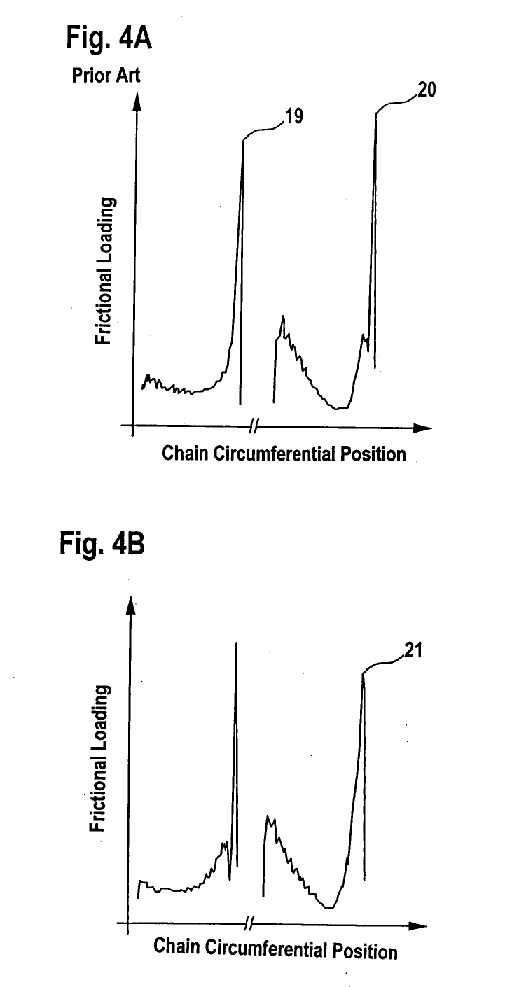

FIG. 4A shows a graphical representation of the frictional loading of a known plate-link chain with a contact point at the bottom on the end faces of the rocker members of the known plate-link chain, in the left half of the drawing upon entering and completely emerging from a driven conical pulley, and in the right half of the drawing a similar representation of the frictional loading upon entering and completely emerging from a driving conical pulley. As can be seen clearly from the peak 19, a frictional loading peak appears at the emergence of the rocker members from the space between the conical disks of the conical pulley. Significantly higher still is the frictional loading peak 20 at the emergence of the rocker members from the intermediate space of the driving conical pulley.

If the representation shown in FIG. 4A is compared with the representation shown in FIG. 4B, the latter of which again shows the pattern of the frictional loading at the contact point between a rocker member and a driven conical pulley for the present invention in the left half of the drawing, and the corresponding pattern of the frictional loading at the driven conical pulley in the right half of the drawing, one is immediately struck by the fact that opposite the peak 20 in FIG. 4A there is now a significantly lower peak 21 in FIG. 4B of the drawing, and thus the frictional loading has decreased significantly, which is in conformity with the smaller wear marks of a rocker member pair in accordance with the present invention as shown in FIG. 3B. In all cases the frictional loading is clearly concentrated in the direction toward the entry into and the emergence from the conical pulley, and that is also where the deflection of the link because of the tilting moment described earlier occurs, which results in a lowering of the frictional loading peak. The so-called instantaneous loading decreases.

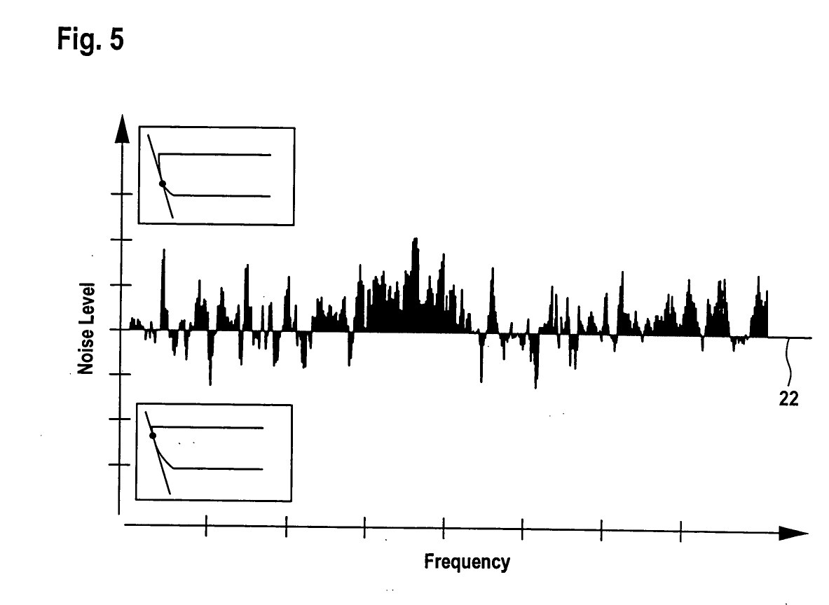

FIG. 5 of the drawings shows a representation of the measured difference in noise level of the two plate-link chains. In the upper half of FIG. 5 there is shown those regions in which a known plate-link chain with a contact point in the lower region of the end face of the rocker members has the higher noise level. In the lower half of FIG. 5 there is shown those regions in which a plate-link chain in accordance with the present invention with a contact between the rocker members and the conical disks in the upper region of the end faces of the rocker members in the height direction of the rocker members has the higher noise level.

If the noise levels lying above and below the line 22 are compared with each other, it immediately becomes evident because of the noise levels plotted over the order or frequency, shown as black regions, that the noise level is significantly greater for the known plate-link chain with the contact point “below” than the noise level for the known plate-link chain with the contact point “above.”

Line 22 of FIG. 5 represents a line at which the noise level of the known plate-link chain and of the plate-link chain in accordance with the invention are identical; and it is immediately noticeable that the noise levels plotted over the order or frequency—and thus the black regions—of the known plate-link chain are significantly greater than the noise levels of the plate-link chain in accordance with the invention. The plate-link chain in accordance with the invention is therefore less acoustically dominant while running, and it is quieter overall.

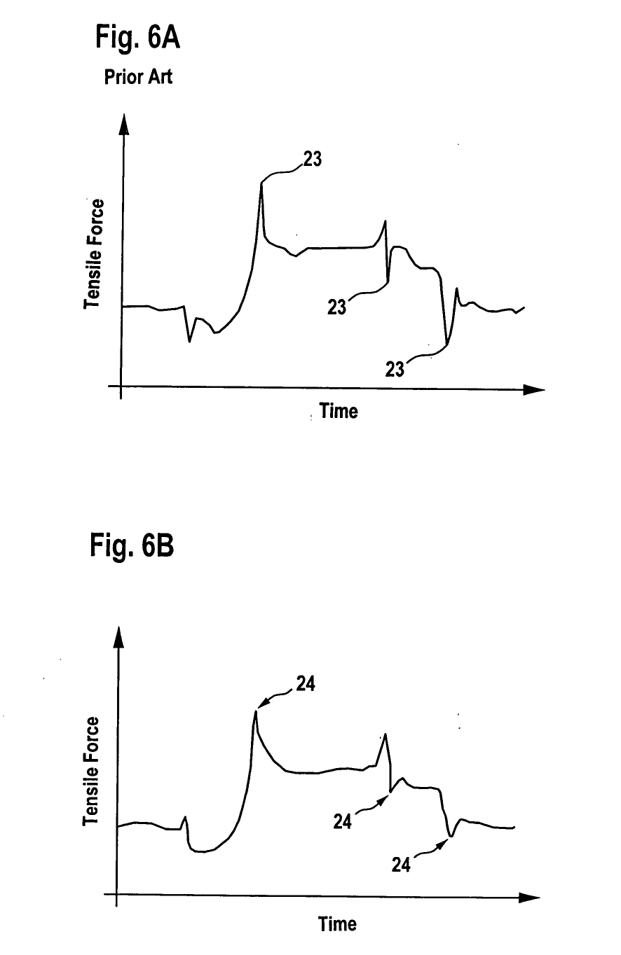

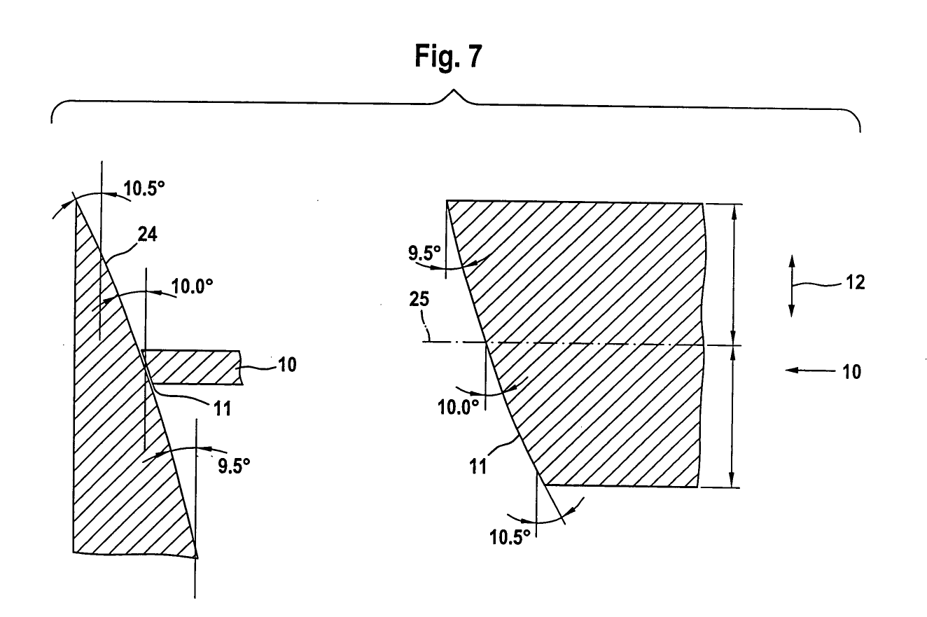

FIG. 6A shows the measured pattern of tensile force acting on a link plate of the known plate-link chain with the contact point “below,” plotted over the time corresponding to one revolution, and it is immediately evident from that figure that the regions designated by reference numeral 23 show significant peaks of tensile force during one revolution of the known plate-link chain.

If FIG. 6A is compared with FIG. 6B, the latter of which shows a corresponding pattern of tensile force, FIG. 6B shows much less sharply defined peaks of tensile force, as can be seen clearly by the peaks 24. The tensile force acting on a link plate during a rotation of the plate-link chain in accordance with the invention shows smaller peak forces in FIG. 6B. That result is achieved by shifting the contact point between the rocker members and the contact disks into the upper region of the end faces of the rocker members, considered in the height direction of the rocker members. With the contact point “above,” the link plate thus has a longer service life, or expressed differently, the torque that can be transmitted by the plate-link chain in accordance with the invention is greater than the torque that can be transmitted by the known plate-link chain. Because of the smaller non-uniformities of force in the regions designated by 24 in the plate-link chain in accordance with the invention, there are fewer or lower force peaks, which makes it possible for the service life of the plate-link chain in accordance with the invention to increase and for vibration excitations and noises to be reduced.

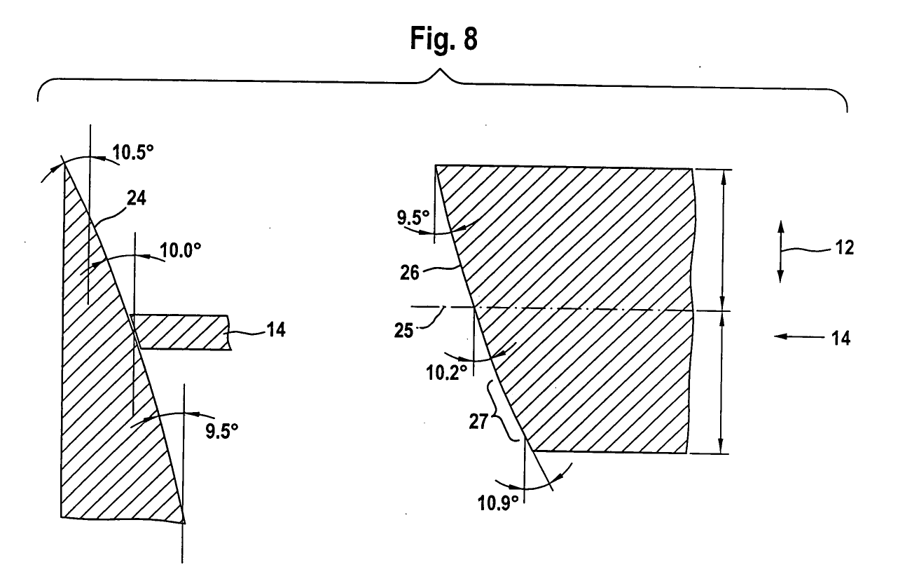

The left half of FIG. 7 of the drawings shows a portion of a schematically represented conical disk surface that is adapted to come into contact with the chain, wherein different disk surface regions have different disk surface inclination angles relative to a plane extending perpendicular to the disk axis of rotation. In the embodiment shown, the conical disk surface 24 has a surface inclination angle of 9.5 degrees, for example, in the radially inner zone, which is thus the lower zone in the drawing. In the center zone the disk surface 24 has a surface inclination angle of 10 degrees, for example, and in the upper zone the disk surface has a surface inclination angle of 10.5 degrees, for example.

During transmission ratio changes rocker member 10 can pass over the entire surface region range with its end face 11, which is shown in enlarged form in FIG. 7 in the right half of the drawing. As can be clearly seen, rocker member end face 11 has angles on its end face that are complementary to the inclination angles of disk surface 24, namely 10.5 degrees in the lower zone, 10 degrees in the middle zone and 9.5 degrees in the upper zone, so that the complete end face region 11 of rocker member 10 can come into contact with the disk surface 24 as the transmission ratio changes. If contact takes place between end face 11 and disk surface 24 in the lower region of end face 11, i.e., below the middle of rocker member 10 when viewed in the height direction of the rocker member and designated by reference numeral 25, the large-region wear marks 13 shown in FIG. 3A result.

The left half of FIG. 8 of the drawings shows a representation that corresponds to the left half of the drawing in FIG. 7, while the right half of FIG. 8 shows an enlarged representation of a portion of an end of rocker member 14 in accordance with the invention. As can be clearly seen, rocker member 14 has an end face 26 whose surface curvature increases from top to bottom in the height direction 12 of the rocker member. End face 26 has a face contour angle of 9.5 degrees in the upper zone. Approximately in the middle 25, viewed in the height direction 12 of the rocker member, the face contour angle is 10.2 degrees, and it increases in the lower zone to 10.9 degrees. Since the face contour angle of the end face 26 thus exceeds the maximum surface inclination angle of 10.5 degrees of the disk surface 24, and a contact point occurs between the conical disk surface 24 and end face 26 of rocker member 14 at matching values of the disk surface angle and the rocker member end face contour angle, and because the disk surface angle has no values that are greater than 10.5 degrees, so that no disk surface angles exist that correspond to the end face contour angles on the end face 26 that exceed the value of 10.5 degrees, contact no longer takes place between the regions of the end face 26 whose face contour angle is greater than 10.5 degrees and disk surface 24. Since the zone of the end face 26 designated by the bracket 27, with face contour angles greater than 10.5 degrees, lies in the lower region of the end face 26 of rocker member 14, relative to the height direction of the rocker member, and below middle 25, that lower region, which occupies about from about 15% to about 35% of the area of end face 26, no longer comes into contact with conical disk surface 24. Hence the contact between rocker member 14 and disk surface 24 takes place in the upper zone of end face 26.

Thus, it is apparent that concentrating the contact of the end face of the rocker member with the surface of the conical disk in a zone of the rocker member end face that does not correspond to the entire rocker member end face is not accompanied by deterioration of the wear behavior, but on the contrary a surprising improvement of the wear behavior has been achieved, and also an acoustically significant improvement.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A plate-link chain for a motor vehicle drive system, said chain comprising: a plurality of link plates having openings and pivotally connected by a plurality of rocker members that extend transversely to the longitudinal direction of the plate-link chain and are positioned in the link plate openings; curved contact surfaces located on a first side of each of the rocker members and on sides of the link plate openings, along which contact surfaces the rocker members and link plates bear against each other to transmit power; curved rolling surfaces formed on a second side of the rocker members, along which pairs of the rocker members roll against each other during curved movement of the chain; wherein the rocker members have end faces for frictional contact with conical surfaces of conical disks of a belt-driven conical-pulley transmission, and wherein the rocker member end faces are so formed that contact between the rocker member end faces and the conical surfaces of the conical disks takes place in an upper contact region of the end faces, above a longitudinally extending middle line of the rocker members.

2. A plate-link chain in accordance with claim 1, wherein the upper contact region on the rocker member end faces extends over from about 65% to about 85% of a height direction of the rocker members.

3. A plate-link chain in accordance with claim 1, wherein the rocker member end faces have increasing curvature from the upper contact region to a lower region relative to a height direction of the rocker members.

4. A plate-link chain in accordance with claim 1, wherein the rocker member end faces have a curvature in a lower region relative to a height direction of the rocker members such that during contact of the rocker member ends with conical surfaces of the conical disks a free space exists between a portion of the rocker member end faces and the conical surfaces of the conical disks.

5. A plate-link chain in accordance with claim 1, wherein when rocker members enter into an intermediate space between two opposed conical disks a tilting moment develops on the rocker members, which tilting moment exerts a force on a following portion of the chain in the running direction of the chain such that an entry curvature radius of a chain portion entering the space between the conical disks is greater than an encircling radius of the chain as it passes around and between the conical disks.

6. A rocker member for a plate-link chain, said rocker member comprising: a rolling surface for contact with a rolling surface of an associated rocker member of a pair of rocker members; curved contact surfaces situated on sides of the rocker members opposite the rolling surfaces; and rocker member end faces for frictional contact with conical surfaces of conical disks of a belt-driven conical-pulley transmission, wherein the rocker member end faces are curved and are so formed that contact between the rocker member end faces and the conical surfaces of the conical disks takes place in an upper region of the end faces, relative to a height direction of the rocker members.

7. A rocker member in accordance with claim 6, wherein the rocker member end faces have increasing curvature from the upper region of the end faces to a lower region, relative to a height direction of the rocker members, such that a contact region on a rocker member end face is from about 65% to about 85% of the area of the end face.

8. A belt-driven conical-pulley transmission comprising: conical pulleys on a power input side and on a power output side; a plate-link chain having rocker members for transmitting torque between the input side conical pulley and the output side conical pulley; wherein the pulleys include a pair of conical disks configured so that contact between end faces of the rocker members and conical surfaces of the conical disks takes place in an upper region of the end faces of the rocker members, relative to a height direction of the rocker members.

9. A belt-driven conical pulley transmission in accordance with claim 8, wherein the conical surfaces of the conical disks are curved, and the curvature of the conical surfaces increases as the radius of the conical disks increases.

10. A belt-driven conical-pulley transmission including a plate-link chain in accordance with claim 1.
